(19) United States
(12) Patent Application Publication
(10) Pub. No.: US 2004/0123579 A1
(43) Pub. Date: Jul. 1, 2004

(54) Stick rake

(76) Inventor: A. James Schutz, Armada, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/733,916

(22) Filed: Dec. 11, 2003

Related U.S. Application Data
(60) Provisional application No. 60/432,438, filed on Dec. 11, 2002.

(51) Int. Cl. A01D 76/00

(52) U.S. Cl. 56/378

(57) ABSTRACT

The present invention provides a machine for gathering sticks and other yard refuse from a ground surface. The machine includes a gathering device and a collection basket for collecting and holding yard refuse from a ground surface. The gathering device includes a frame that supports an elongated rotor and a gasoline engine for driving the rotor about its longitudinal axis. The elongated rotor includes a plurality of axially spaced tines mounted thereon that extend perpendicular to the longitudinal axis and operative to gather the yard refuse from the ground surface and deposit it into the collection basket as the gathering device is moved over the ground surface.

### RELATED APPLICATION

The present application claims the benefit of U.S. Provisional Patent Application Serial No. 60/432,438 filed Dec. 11, 2002.

### FIELD OF THE INVENTION

The present invention relates to machines used for landscaping and lawn maintenance and more particularly to a machine adapted to pick up sticks and other debris from a ground surface.

### BACKGROUND OF THE INVENTION

It is frequently necessary to gather sticks and small branches from a yard or landscape that have fallen from the trees. The fallen sticks or branches can potentially cause harm to pedestrians as well as being potentially damaging to lawnmowers and other lawn care equipment. Currently there exists no device for effectively gathering sticks and twigs from a lawn or landscape that does not require some hands-on involvement from the user. Accordingly, it is the object of the present invention to provide a device that can be used to gather sticks and branches from parks, golf courses, landscapes and lawns where a fair amount of sticks and other debris accumulate.

### SUMMARY OF THE INVENTION

The present invention provides an apparatus that has utility for picking up sticks and other debris from a ground surface.

The apparatus comprises a gathering device that includes a frame for supporting an elongated rotor and a motor for driving the elongated rotor. The rotor has a longitudinal axis and a plurality of spaced-apart tines extending perpendicular to the longitudinal axis disposed on an exterior surface. The tines are operative to gather yard refuse from the ground surface when being rotatably driven by the motor and being moved over the ground surface.

A vertical adjustment mechanism is operative to adjust the position of the rotor with respect to the ground surface and thus allows for the tines to be positioned relative to the ground surface for optimal collection of yard refuse while moving over the ground surface.

A basket is provided which cooperates with the gathering device for holding the yard refuse collected by the gathering device from the ground surface. The basket is operative to be selectably removed from the gathering device for emptying as required.

### BRIEF DESCRIPTION OF THE DRAWINGS

A better understanding of the present invention will be had upon reference to the following detailed description when read in conjunction with the accompanying drawings in which like parts are given like reference numerals and wherein:

FIG. 1 is a perspective view of the stick rake as according to the invention;

FIG. 2 illustrates the elongated rotor of the stick rake having a plurality of tines disposed thereon for gathering yard refuse;

FIG. 3 illustrates the stick rake wherein the collection basket is pivotally retracted for emptying yard refuse therefrom;

FIG. 4 illustrates a partial side view of the stick rake wherein a lower shield is disposed on a lower portion of the gathering device to enhance collection of the yard refuse into the collection basket; and

FIG. 5 illustrates the collection basket having an access door for permitting access to the interior of the collection basket when it is positioned for debris collection.

### DETAILED DESCRIPTION OF THE INVENTION

The present invention provides a device for picking up sticks and other yard refuse from a ground surface disposed with trees such as parks, golf courses, landscapes and lawns.

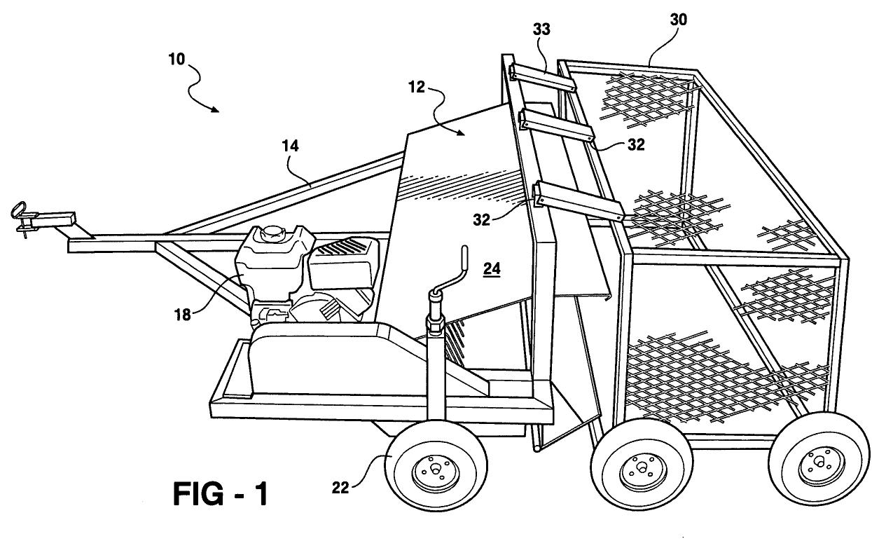

Referring to FIG. 1, a stick rake apparatus 10 that is adapted for gathering sticks and other yard refuse from a ground surface is illustrated.

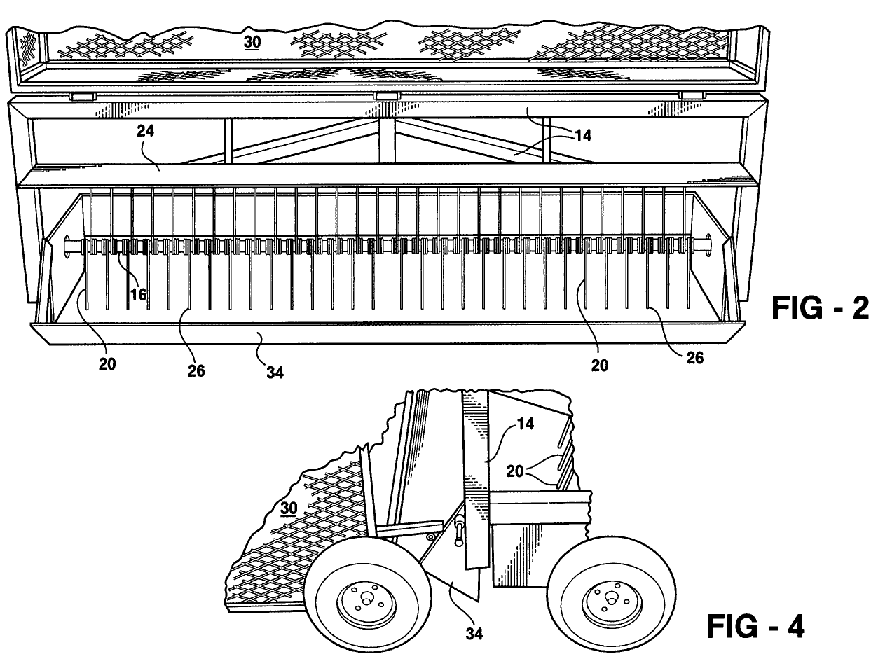

As best shown in FIG. 2, the apparatus 10 includes a gathering device 12 having a frame 14 that supports an elongated rotor 16 and a motor 18.

The motor 18 is provided in mechanical communication with the elongated rotor 16 and is operative to rotatably drive the elongated rotor 16 about its longitudinal axis A. Preferably, the motor 18 outputs sufficient speed and torque for driving the elongated rotor 16 to accomplish gathering sticks from approximately 1 inch in diameter to 1½ inches in diameter and having a length up to 5 feet. Illustratively, the motor 18 may be provided as a 6.5 horsepower gasoline engine in communication with the elongated rotor through a belt and pulley system which allows for the engine to rotatably drive the rotor 16 accordingly. Other conventional drive machines and mechanisms may also be adapted for such purpose without exceeding the scope of the invention.

The elongated rotor 16 includes a plurality of spaced apart tines 20 extending perpendicular to the longitudinal axis A of the elongated rotor 16. The tines 20 are operative to gather yard refuse from the ground surface when the elongated rotor 16 is being rotatably driven by the motor 18 and the gathering device 12 is being moved over the ground surface. Preferably, each of the plurality of tines 20 includes a distal end 26 that is bent outwardly toward the direction of rotation of the elongated rotor 16. In this manner, the tines 20 perform a hooking and scooping action for lifting the fallen limbs and branches from the ground surface. Preferably, the tines have a diameter which ranges from ½ to 1½ inches, most preferably 1 inch, and a length of 5 to 9 inches, most preferably 7 inches. It is appreciated that other diameters and lengths for the tines 20 may be adopted such that the collection of yard refuse is optimized using the inventive apparatus 10.

Preferably, the length of the elongated rotor ranges from 36 to 108 inches in length, most preferably 78 inches in length. However, it is appreciated that other lengths may be used for the rotor without exceeding the scope of the invention. For gathering sticks, the tines 20 disposed on the elongated rotor 16 are preferably spaced apart approximately 4⅛ inches on center. For gathering other types of yard refuse such as leaves, grass, or when using the gathering device 12 for thatching, the elongated rotor 16 may be replaced with an elongated rotor having tines designed for the specific type of yard refuse to be collected from the ground surface. Accordingly, it is appreciated that the elongated rotor 16 is adapted to be selectably replaceable with one adapted for accomplishing optimal gathering of the desired yard refuse.

Referring again to FIG. 1, the gathering device 12 includes an upper shield 24 that prevents the collected yard refuse from being ejected out from the gathering device 12 when in operation. Additionally, as best shown in FIG. 4, a lower shield 34 is provided for cooperating with the elongated rotor 16 and tines 20 to direct the yard refuse into the basket 30. The lower shield 34 is positioned at a raised incline between the ground surface and a lower front edge of the basket 30 such that gathered sticks are directed up from the ground surface and into the basket rather than being directed beneath the basket.

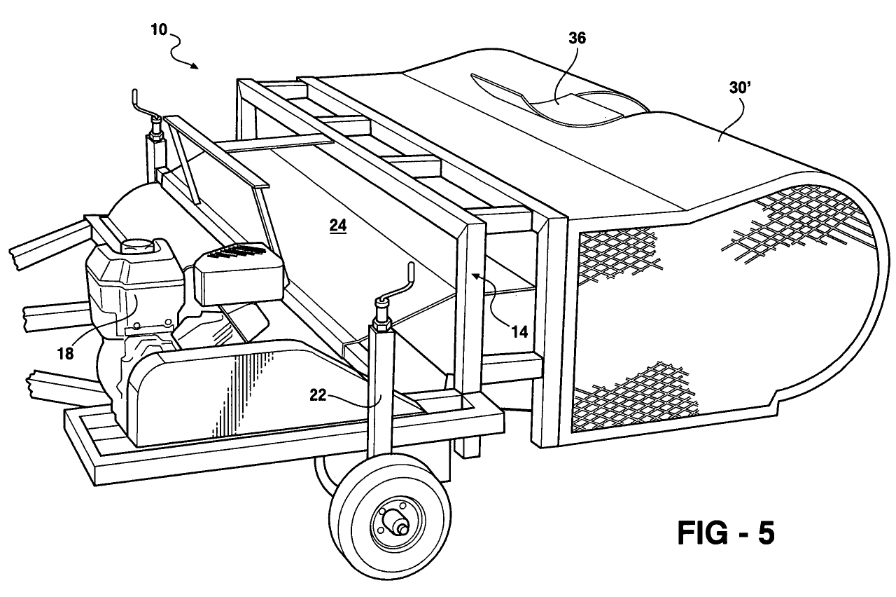

Referring now to FIG. 5, a vertical adjustment mechanism 22 is provided for allowing the user to control the depth of the gathering device 12 in relation to the ground surface. It is appreciated that depth control is critical for optimizing the collection of various types of yard refuse by the gathering device 12. In a preferred embodiment, two telescopically and vertically adjustable mechanisms 22 are provided adjacent the opposing ends of the elongated rotor 16. A screw rod is pivotally attached to one end of an inner tube that is telescopically disposed in a larger outer tube. The screw rod extends through a nut at the top of the larger outer tube for allowing adjustment of the wheel position in a worm drive fashion. Preferably, the depth position is adjustable manually; however, it is appreciated that the depth position may be motor driven as an option to manual adjusting.

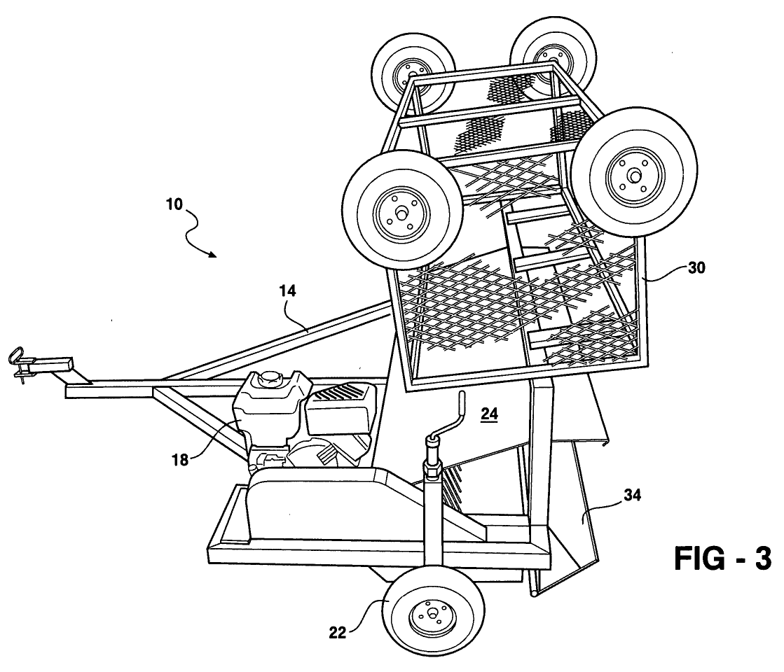

Still referring to FIG. 5, the collection basket may be provided with an optional access door 36 for allowing the user to have access to the interior of the collecting basket 30 when the basket 30 is disposed in the down position as shown. In some cases, access may be required for allowing the user to redistribute collected yard refuse such that the holding capacity of the basket 30 is maximized for each use. As briefly described above, the basket 30 is selectably removable and preferably hingedly attached to the gathering device 12 such that it can be pivotally adjusted to an open position for emptying (see FIG. 3). In a preferred embodiment, a top portion of the basket 30 is mounted to a portion of the frame 14 of the gathering device 12 by at least one hingedly attached arm 33 having pivot points 32 at opposing ends as best shown in FIG. 1. Preferably a set of linkages is provided along the lower cross member of the open side of the basket 30. The set of linkages are selectably releasable for allowing the basket 30 to be fully retracted 180° on the hinged arms 33 to rest on an upper portion of the gathering device 12 whereby the yard refuse can be readily emptied from the basket 30.

As mentioned above, a preferred embodiment of the stick rake 10 is designed to pick up sticks as small as a pencil to as large as 1½ inches in diameter and having a length of up to 5 feet. The stick rake apparatus 10 may be pulled by a garden tractor or may be provided as a standalone motorized unit provided with control means that allows for the apparatus 10 to be operated in a fashion similar to a riding mower. For optimum utility, sticks next to the bases of trees are moved to a position out far enough from the trunks of the trees for the apparatus 10 to be able to pick them up accordingly. The apparatus may be adapted for collecting various types of yard refuse by adjusting the vertical position of the gathering device 12 and/or by changing the elongated rotor to one best suited for collecting the desired yard refuse.

From the foregoing it is appreciated that the present invention provides an apparatus for gathering yard refuse from a ground surface and more particularly to an apparatus for gathering sticks from a yard or landscape. It is appreciated that upon reading the foregoing specification that one skilled in the art will realize changes and modifications that do not depart from the spirit of the invention as defined by the scope of the appended claims.

I claim:

1. An apparatus operative for gathering yard refuse from a ground surface, said apparatus comprising:
a gathering device having a frame and a motor, said frame supporting an elongated rotor having a longitudinal axis, said elongated rotor being disposed with a plurality of spaced apart tines extending perpendicular to the longitudinal axis, said elongated rotor driven by said motor, said tines operative to gather yard refuse from the ground surface when rotating and being moved over the ground surface;
a pair of wheels operative to support said frame on the ground surface;
an adjustment mechanism disposed between said pair of wheels and said frame to adjust the position of the elongated rotor with respect to the ground surface; and
a basket for holding the yard refuse collected from the ground surface by the gathering device.

2. The apparatus of claim 1 wherein the gathering device further comprises a shield for preventing the collected yard refuse from being ejected out from said gathering device.

3. The apparatus of claim 1 wherein the tines include distal ends that are bent outwardly toward a direction of rotation of the elongated rotor.

4. The apparatus of claim 1 wherein the basket is a hinged basket adapted to be selectably attachable to the gathering device.

5. The apparatus of claim 1 wherein the tines have a diameter of ½-1½ inches and a length of 5-9 inches.

6. The apparatus of claim 1 wherein the gathering device is further operative for thatching a lawn.

7. The apparatus of claim 1 wherein the elongated rotor is 36-108 inches in length.

8. The apparatus of claim 1 wherein the elongated rotor is selectably attachable to the gathering device.

9. An apparatus adapted to be towed by a vehicle and operative for gathering yard refuse from a ground surface, said apparatus comprising:
a gathering device having a frame that supports an elongated rotor and a motor in communication with said elongated rotor, said elongated rotor having a plurality of spaced apart tines and mounted to said frame to be rotatably driven by said motor, said tines operative to gather yard refuse from the ground surface when rotating and being towed over the ground surface;
a pair of wheels operative to support said frame on the ground surface;
an adjustment mechanism disposed between said pair of wheels and said frame to adjust the position of the elongated rotor with respect to the ground surface; and
a basket for holding the yard refuse collected from the ground surface by the gathering device.

10. The apparatus of claim 9 wherein the gathering device further comprises a shield for preventing the collected yard refuse from being ejected out from said gathering device.

11. The apparatus of claim 9 wherein the tines include distal ends that are bent outwardly toward a direction of rotation of the rotor.

12. The apparatus of claim 9 wherein the basket is a hinged basket adapted to be selectably attachable to the gathering device.

13. The apparatus of claim 9 wherein the elongated rotor is selectably attachable to the gathering device.

14. An apparatus adapted to be towed by a vehicle and operative for gathering sticks from a ground surface, said apparatus comprising:
a gathering device having a frame that supports an elongated rotor and a motor in communication with said elongated rotor, said elongated rotor having a plurality of spaced apart tines and operative to be rotatably driven by said motor, said tines operative to gather sticks from the ground surface when rotating and being towed over the ground surface;
a pair of wheels operative to support said frame on the ground surface;
an adjustment mechanism disposed between said pair of wheels and said frame to adjust the position of the elongated rotor with respect to the ground surface; and
a basket for holding the sticks collected from the ground surface by the gathering device.

15. The apparatus of claim 14 wherein the gathering device further comprises a shield for preventing the collected sticks from being ejected out from said gathering device.

16. The apparatus of claim 14 wherein the tines include distal ends that are bent outwardly toward a direction of rotation of the rotor.

17. The apparatus of claim 14 wherein the basket is a hinged basket adapted to be selectably attachable to the gathering device.

18. The apparatus of claim 14 wherein the tines have a diameter of ½-1½ inches and a length of 5-9 inches.

19. The apparatus of claim 14 wherein the gathering device is further operative for thatching a lawn.

20. The apparatus of claim 14 wherein the elongated rotor is selectably attachable to the gathering device.
